(19) United States
(12) Patent Application Publication
(10) Pub. No.: US 2007/0125857 A1
(43) Pub. Date: Jun. 7, 2007

(54) Information carrier comprising a non-clonable optical identifier

(75) Inventors: Pim Theo Tuyls, Eindhoven (NL); Boris Skoric, Eindhoven (NL); Sjoerd Stallinga, Eindhoven (NL); Willem Gerard Ophey, Eindhoven (NL); Antonius Hermanus Maria Akkermans, Eindhoven (NL); Petra Elisabeth De Jongh, Utrecht (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/579,152

(22) PCT Filed: Nov. 3, 2004
(86) PCT No.: PCT/IB04/52283

§ 371 Date: May 12, 2006

(30) Foreign Application Priority Data
Nov. 17, 2003 (EP) 03104226.0

(51) Int. Cl. G06K 7/10

(52) U.S. Cl. 235/454

(57) ABSTRACT

The invention relates to an information carrier containing a non-clonable optical identifier (2) having an optical scattering medium (3) for being challenged by a light beam (5) and for scattering said light beam (5). In order to provide a secure information carrier (1), it is proposed that it further comprises a light absorbing means (3, 4) for reducing the intensity of said light beam (5) so that an integration time for obtaining a response signal by integrating the scattered light beam (8) is extended.

The invention relates to an information carrier containing a non-clonable optical identifier, to a reading apparatus for reading an information carrier and to a method for identifying an information carrier.

The use of “physically unclonable functions” (PUFs) for security purposes is known, e.g. from the article “Physical One-Way Functions” Ravikanth Pappu et al., Vol. 297 SCIENCE, 20/09/2002. Incorporating a PUF into a product such as a smartcard, chip, or storage medium makes it extremely difficult to produce a “clone” of the product. “Clone” means either a physical copy of the product or a model that is capable of predicting the input-output behavior of the product with reliability. The difficulty of physical copying arises because the PUF manufacturing is an uncontrolled process and the PUF is a highly complex object. Accurate modeling is extremely difficult because of the PUF's complexity; slightly varying the input results in widely diverging outputs. The uniqueness and complexity of PUFs makes them well suited for identification, authentication or key generating purposes.

Optical PUFs can consist of a piece of, e.g., epoxy containing glass spheres, air bubbles or any kind of scattering particles. The epoxy can also be replaced by some other transparent means. Generally, PUFs are called identifier hereinafter. Shining a laser through a PUF produces a speckle pattern which strongly depends on properties of the incoming wave front and on the internal structure of the PUF. The input (wave front) can be varied by shifting or tilting the laser beam or by changing the focus. The wave front can also be changed by placing a spatial light modulator (SLM) in the path of the laser beam. The SLM consists of an array of transparent/dark pixels deciding which part of the laser beam is transmitted or blocked, respectively. Alternatively, an SLM can consist of an array of phase-changing pixels, or of an array of micro-mirrors. If the number of challenges producing different and independent responses is given by a number which is not very large, the attacker might well be able to clone the identifier.

It is therefore an object of the invention to provide a secure information carrier with an improved non-clonable optical identifier and to provide a reading apparatus for reading an information carrier. It is further an object of the invention to provide a method for identifying an information carrier.

The object is achieved by an information carrier as claimed in claim 1.

The invention is based on the recognition that in order to hamper an attempt to clone an identifier by challenging it with all possible challenges and to store the detected responses, it is possible, in alternative or in addition to enlarging the challenge space, to extend the time required to obtain a single response, so that the time for making a model is too long for a realistic hacking scenario, e.g., several years. It has been found that the time for obtaining a single measurement could be extended simply by using a light absorbing means for reducing the intensity of the incident light beam, which is preferably a laser beam generated by a laser. This light absorbing means is arranged next to the optical scattering medium, either before the light beam impinges on the scattering medium or after the light beam has passed the scattering medium. The light absorbing means extends the integration time needed for obtaining response signals, making the identifier more secure.

In an embodiment, the information carrier according to the invention has the features claimed in claim 2. The gray filter reduces the light intensity, preferably before the light beam is incident on the epoxy containing the scattering particles. Epoxies, scattering particles and gray filters are cheap and easy to manufacture.

In an embodiment, the information carrier according to the invention has the features claimed in claim 3. In this embodiment the light beam intensity in normal use cannot exceed a threshold intensity because then the phase change layer darkens permanently making the identifier unusable. In this embodiment, the identifier is additionally protected against optical scrutiny with high-intensity light. A phase change material to be used for this purpose may be GeSbTe which, above a certain threshold temperature, may change from the crystalline state into the amorphous state or visa versa.

In an embodiment, the information carrier according to the invention has the features claimed in claim 4. In this embodiment the layer darkens temporarily making the scattering medium and the optical identifier unusable for some period of time. In this embodiment, the identifier is additionally protected against optical scrutiny with high-intensity light, but the identifier does not become permanently unusable. A commercially available photochrome material to be used for this purpose is MXP7-114 from PPG industries, which is mostly used for coloring sun glasses. Its full chemical name is 3,3-di(4-methoxyphenyl)-13-hydroxy-13-methyl-indeno[2,1-f]naphtho[1,2b]pyran.

In an embodiment, the information carrier according to the invention has the features claimed in claim 5. There is no threshold value, and the rate of darkening is proportional to the light intensity. After a certain number of ordinary uses, the identifier becomes unusable. In this embodiment, the identifier is protected against optical scrutiny with high-intensity light and also against repeated scrutiny at normal light intensities. A permanently photo sensitive darkening material may be silver chloride.

In further embodiments, the information carrier according to the invention has the features claimed in claims 6 or 7. These embodiment have the advantage that light absorbing means provided in other embodiments, such as a gray filter, cannot be removed by a hacker.

In further embodiments, the information carrier according to the invention has the features claimed in claims 8 or 9.

The object is also achieved by a reading apparatus as claimed in claim 10.

In an embodiment, the reading apparatus according to the invention has the features claimed in claim 11. If an information carrier with a non-authorized optical identifier is put into the reading apparatus a certain challenge causes a response being detected which differs from the response stored in the storage means. The user is authorized only, if the responses stored in the storage means are identical to the detected responses.

In further embodiments, the reading apparatus according to the invention has the features claimed in claims 12, 13 or 14. A SLM consists of an array of pixels. Pixels can be switched from transparent to dark changing the wave front.

It is also possible to provide a slowly switching light modulator to extend the integration time. The time to switch an array should exceed 1 ms. This slowly switching SLM can also be attached to the identifier in such a way that removal of the SLM damages the identifier, making it unusable. However, the light modulator can also be part of the reading apparatus. The slowness is preferably provided by use of a particular material which has appropriate inherent material properties, such as a slow liquid crystal.

The object is further achieved by a method according to claim 15 and by an identifier, preferably for use in an information carrier, as claimed in claim 16. Preferred embodiments of the products and of the method are defined in the dependent claims.

These and other aspects of the invention will be further described with reference to the drawings, in which:

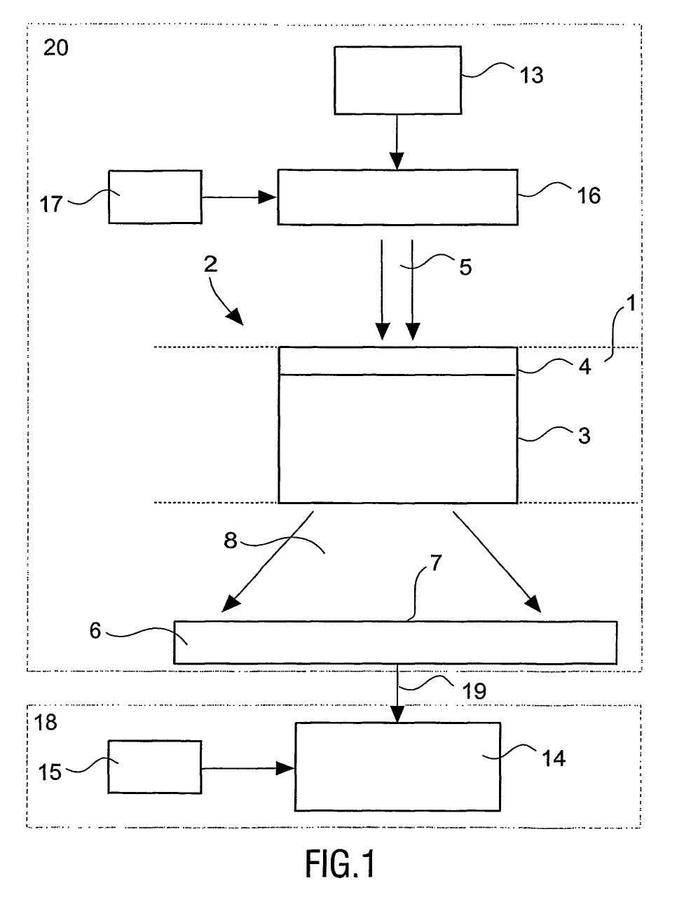

FIG. 1 shows a principal arrangement containing an information carrier according to the invention,

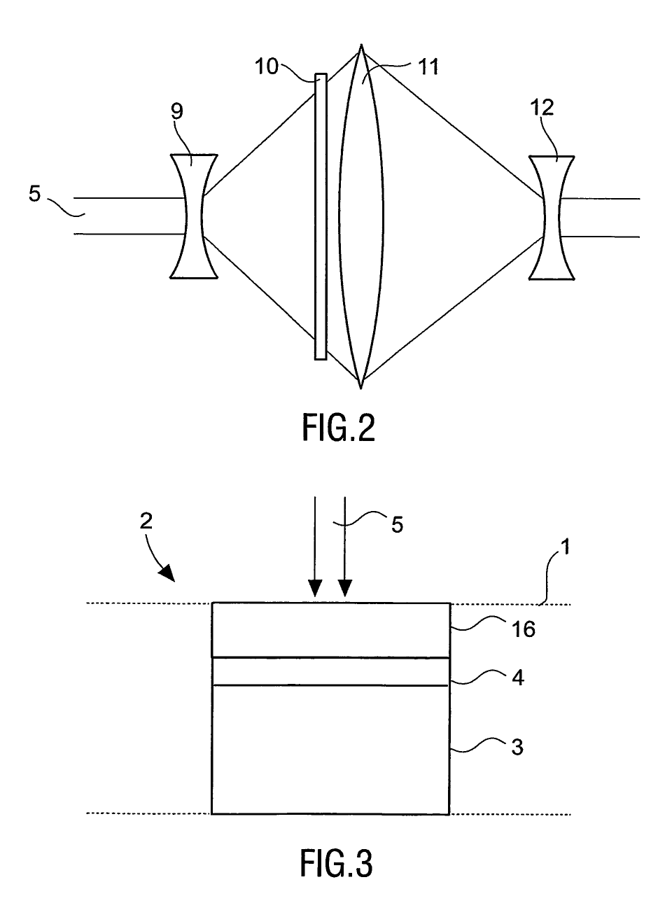

FIG. 2 shows an arrangement of a reading apparatus according to the invention and

FIG. 3 shows another embodiment of an information carrier according to the invention.

FIG. 1 shows an information carrier according to the invention, e.g. a smartcard 1, indicated by dotted lines. The smartcard includes a non-clonable optical identifier 2 (i.e. the PUF) comprising a piece of epoxy 3 and a gray filter 4. A gray filter 4 is arranged and deposited on one side of the epoxy 3 where a laser beam 5 emitted from a laser 13 incidents.

A reading apparatus for reading the information carrier 1 comprises mainly the laser 13 and a detector 6. The smartcard 1 with the non-clonable optical identifier 2 and the reading apparatus are arranged such that the laser beam 5 shines on the gray filter 4 which thus reduces the intensity of the laser beam 5. The laser beam 5 propagates with reduced intensity through the epoxy 3 and is scattered by scattering particles (not shown) contained in the epoxy 5 resulting in a scattered laser beam 8.

The detector 6 is arranged on the side of the smartcard 1 opposite to the laser 13. The detector 6 detects a speckle pattern 7 caused by the scattered laser beam 8. By integrating over a certain period of time a response signal is thus obtained at the detector 6. The integration time due to the filter 4 on the identifier is preferably longer than 1 ms.

Before a laser beam 5 is incident on the gray filter 4 it passes a spatial light modulator (SLM) 16. The light modulator 16 contains an array of dark and bright pixels, which can be switched by a control unit 17. The laser beam 5 passing a set array is called a challenge, which incidents on the gray filter 4. The speckle pattern 7 assigned to this challenge is a response. For each array there exists a certain assigned response.

The typical protocol for issuing and checking if the smartcard 1 is authenticated is as follows (using an example of a bank 18 checking a user's smartcard 1). First, there is an “enrolment” phase. The bank 18 takes a freshly produced smartcard 1 with PUF, measures a number of challenge and response (CR) pairs and stores them in a memory 15, e.g. on a hard disk. Usually, not all possible CR pairs are stored since this would take too long. Then the smartcard 1 with PUF is given to the account holder (“user”).

The second phase is the authentication phase. The user presents his smartcard 1 to a reader 20. The reader 20 contacts the bank. The bank 18 selects one challenge from its limited database 15. If the user really possesses the PUF he is able to give the correct response which is checked, e.g. by a comparator in the bank 18. A secure channel 19 is formed between the reader 20 and the bank 18, based on their shared secret knowledge of the PUF's response. There are several ways of agreeing on an encryption key for the secure communication over the insecure line between user and bank. A CR pair should be used for authentication only once. The secure channel 19 can be used to refresh the bank's database of CR pairs: the bank 18 sends a number of random challenges and the PUF sends back the responses. These CR pairs can later be used for authentication.

It should be noted that the memory 15 and the comparator 14 can also be part of the reading apparatus 20.

To clone the optical identifier 2 it is necessary for the backer to challenge the epoxy 3 with all possible challenges of bright and dark pixel combinations, and to store the responses. These challenge-response pairs characterize the epoxy 3 completely.

If the SLM contains M switchable pixels, the hacker has to do M (M+1)/2 measurements to figure out the speckle pattern I(x,y) for all challenges. This can be understood as follows. If the light front (including phase information) due to a single transparent pixel i hitting the detector 6 is denoted as fᵢ(x,y) and the light front due to two transparent pixels i and j as fᵢⱼ(x,y), then the measured speckle pattern intensities Iᵢ(x,y) and Iᵢⱼ(x,y) are given by
Iᵢ=|fᵢ|²
Iᵢⱼ=|fᵢ+fᵢ|²=Iᵢ+Iⱼ+(fᵢ*fⱼ+fⱼ*fᵢ)≡Iᵢ+Iⱼ+Cᵢⱼ,
where the cross terms have been denoted by Cᵢⱼ. The hacker measures all speckle patterns Iᵢ and Iᵢⱼ. These are M(M+1)/2 in number. An arbitrary challenge is represented as a list specifying which pixels are transparent (aᵢ=1) and which are blocking (aᵢ=0).

The resulting speckle pattern I(x,y) is given by

$$\begin{matrix}I = {\vert {\sum }_{i = 1}^{M} {a}_{i} {f}_{i} \vert}^{2} \\ = {\sum }_{i = 1}^{M} {a}_{i} {\vert {f}_{i} \vert}^{2} + {\sum }_{i \neq j} {a}_{i} {a}_{j} ( {f}_{i}^{*} {f}_{j} + {f}_{j}^{*} {f}_{i} ) \\ = {\sum }_{i = 1}^{M} {a}_{i} {I}_{i} + {\sum }_{i \neq j} {a}_{i} {a}_{j} {C}_{ij} .\end{matrix}$$

Since all Iᵢ and Cᵢⱼ are known to the hacker, the speckle pattern can be rebuilt from the Iᵢ and Cᵢⱼ and the challenge {aᵢ}. Thus, a successful attack can be mounted in a polynomial amount of time, approximately M²/2 measurements which is considered insecure.

Though only M² measurements are necessary for cloning the identifier it can in practice be sufficiently large to thwart attacks. This follows from the fact that the measurement on an identifier 2 takes a finite amount of time. If, for instance, the time needed to measure one challenge is 10⁻⁴ s, and M=10⁶, an exhaustive attack takes 10⁸ s which is approximately three years. Therefore an identifier 2 has to be made slow. The slowness of the measurement process should result from the physical properties of the identifier 2. A detector 6 measuring an optical speckle pattern 7 needs a minimum amount of time to integrate the incoming scattered light 8. This time is usually called integration time and depends on the intensity of the light. The integration time also depends on the amount of noise in the detector 6. A lower bound on the noise level is given by the so-called shot noise. This gives a fundamental physical lower bound on the integration time. Hence, it can never be reduced by better technologies.

Assuming that the laser emits light of total power P, this power is attenuated by the identifier 2 and the gray filter 4 with a factor η_{PUF}P. The laser beam 5 consists of photons with energy hc/λ, where λ is the wavelength of the light in vacuum, h is Planck's constant, and c is the speed of light in vacuum. The average number of photons per second incident on the detector 6 is then η_{PUF}Pλ/hc. The detector 6 consists of M pixels giving the average number of photons per second incident on a pixel as η_{PUF}Pλ/hcM. In the detector 6 the photons are converted to electrons with quantum efficiency η_{Q} giving an average number of η_{Q}η_{PUF}Pλ/hcM electrons per second per pixel. The electrons are collected during a certain time interval, the integration time T. The actual signal Nₑ is the total collected number of electrons during the integration time T, and is read out with the frame frequency 1/T. The generation of photo-electrons at the detector 6 is a Poissonian process, so Nₑ is a statistical variable. The average and variance of Nₑ are equal and given by:

$$〈 {N}_{e}^{2} 〉 - {〈 {N}_{e} 〉}^{2} = 〈 {N}_{e} 〉 = \frac{{η}_{Q} {η}_{PUF} P λ}{hcM} T ,$$

The ratio of signal power and noise power then follows as:

$$SNR = \frac{{〈 {N}_{e} 〉}^{2}}{〈 {N}_{e}^{2} 〉 - {〈 {N}_{e} 〉}^{2}} = \frac{{η}_{Q} {η}_{PUF} P λ}{hcM} T .$$

In practice this is the upper limit for the signal-to-noise ratio, as other noise sources are not taken into account. It follows that the integration time must be at least:

$$T \geq \frac{hcM \cdot SNR}{ {η}_{ Q} {η}_{ PUF} P λ} .$$

The number R of useful bits (encoding the gray levels) that is extracted from the measured signal per pixel is limited according to Shannon's theorem:

$$R \leq C = \frac{1}{ 2} {log}_{ 2} [ 1 + SNR ] .$$

As there are M pixels, the response contains K=RM=ξCM useful bits, where ξ is the efficiency of the code that extracts the useful bits from the channel bits. It now follows that the integration time is bounded to:

$$T \geq \frac{hcM ( {2}^{2 K / {M}_{ς}} - 1 )}{{η}_{Q} {η}_{PUF} P λ} = \frac{hcM ( {2}^{2 C} - 1 )}{{η}_{Q} {η}_{PUF} P λ} .$$

All the variables on the right hand side are at the user's disposal to make this lower bound for the integration time sufficiently high to make the attack futile. To increase the integration time the number of pixels M can be increased, the number of gray levels per pixel (2^{C}) can be increased, the quantum efficiency of the detector (η_{Q}) can be decreased by designing a silicon under the detector 6 appropriately, transparency of epoxy 3 and/or the gray filter 4 (η_{PUF}) can be decreased or the power of the laser beam 5 can be decreased. Furthermore, the wavelength of the laser beam 5 can be decreased, i.e. it is advantageous to use a blue laser instead of a red laser.

Estimating the integration time for a realistic situation, the following values for the parameters can be used: h=6.6*10⁻³⁴ Js, c=3*10⁸ m/s, M=10⁶, C=4, η_{Q}=3*10⁻¹, η_{PUF}=10⁻², P=10⁻³ W and λ=5*10⁻⁷ m. Then, the integration time becomes T=10⁻⁴ s. The total time Tₜₒₜ=T*M² for cloning the identifier 2 is then approximately 3 years.

FIG. 2 shows parts of another embodiment of a reading apparatus according to the invention. Therein, the laser beam 5 is widened by a first concave lens 9. The widened beam passes an SLM 10. In the path of the laser beam a convex lens 11 is arranged next to the SLM 10 for narrowing the laser beam. A second concave lens 12 straightens the laser beam. This arrangement allows a large number of pixels for a laser beam with a small radius because the SLM 10 is arranged in a section of the laser beam, where the laser beam is widened already.

Generally, the PUF 2 is preferably made of epoxy containing micron-scale scattering particles such as glass spheres or rods, metals, metal-oxides, phase-change materials such as GaSb alloy and photo-chemical materials such as AgBr₂. These are very cheap, and the production process is uncontrolled. The detector 6 is preferably a CCD or CMOS-type.

Instead of providing the SLM control unit 17 and the light modulator 16 (10) in the reading apparatus, they can also be placed on the information carrier itself. The SLM may then take the role of a shutter which keeps the PUF in the dark as long as it is not used. An embodiment of such an information carrier is shown in FIG. 3.

The described invention improves identifiers for, e.g., smartcards. Known identifiers make use of large challenge spaces making it, practically, impossible to collect all challenge-response pairs for cloning the identifier. The present invention provides secure identifiers by providing a light absorbing means to extend the integration time to obtain a reliable signal. Further, an identifier can be provided which is, in principle, insecure because of a small challenge space, but is made secure by use of the invention. This leads to a smaller and cheaper identifier, which is suitable for miniaturization.

1. Information carrier containing a non-clonable optical identifier (2) comprising:
an optical scattering medium (3) for being challenged by a light beam (5) and for scattering said light beam (5), and
a light absorbing means (3, 4) for reducing the intensity of said light beam (5) so that an integration time for obtaining a response signal by integrating the light beam scattered (8) is extended.

2. Information carrier as claimed in claim 1, characterized in that said light absorbing means comprises a gray filter (4) attached to said optical scattering medium (3).

3. Information carrier as claimed in claim 1, characterized in that said light absorbing means comprises a phase change layer, which darkens permanently when the intensity of said light beam (5) is above a threshold intensity.

4. Information carrier as claimed in claim 1, characterized in that said light absorbing means comprises a photo layer, which darkens temporarily when the intensity of said light beam (5) is above a threshold intensity.

5. Information carrier as claimed in claim 1, characterized in that said light absorbing means comprises a photo layer which darkens permanently when exposed to light.

6. Information carrier as claimed in claim 1, characterized in that said scattering medium (3) and said light absorbing means are integral.

7. Information carrier as claimed in claim 6, characterized in that said light absorbing means are implemented by using a scattering material having a low light transmittance or reflectance, containing scattering particles of phase-change material or photo-effect material.

8. Information carrier as claimed in claim 1, characterized in that said non-clonable optical identifier further comprises a light modulator (16) on the side of the information carrier for facing said light beam (5).

9. Information carrier as claimed in claim 8, characterized in that said light modulator (16) has a switching time larger than 1 ms.

10. Reading apparatus for reading an information carrier (1) containing a non-clonable optical identifier (2) comprising an optical scattering medium (3) for being challenged by a light beam (5) and for scattering said light beam (5), and a light absorbing means (3, 4) for reducing the intensity of said light beam (5) so that an integration time for obtaining a response signal by integrating the light beam scattered (8) is extended, said reading apparatus comprising:
a light source (13) for emitting a light beam (5) for challenging the optical identifier (2) of said information carrier (1),
a detector (6) for detecting scattered light (8) scattered by the scattering medium (3) of said information carrier (1) and for integrating said scattered light (8) over a period of time for obtaining a response signal to be used for comparing to a stored response signal associated with a corresponding challenge signal.

11. Reading apparatus as claimed in claim 10, further comprising:
a storage means (14) for storing challenge signals and associated response signals for said identifier (2), and
a comparison means (15) for comparing the obtained response signal with the stored response signal associated with a corresponding challenge signal.

12. Reading apparatus as claimed in claim 10, further comprising a light modulator (16) arranged between the light source (13) and the identifier (2) when the information carrier is present inside the reading apparatus.

13. Reading apparatus as claimed in claim 12, characterized in that said light modulator (16) contains an array of dark and bright pixels, wherein the array can be switched.

14. Reading apparatus as claimed in claim 12, further comprising a lens system (9, 11, 12) for widening the light beam (5), wherein the light modulator (16) is arranged in a widened section of the light beam (5).

15. Method for identifying an information carrier containing a non-clonable optical identifier (2) comprising an optical scattering medium (3) for being challenged by a light beam (5) and for scattering said light beam (5), and a light absorbing means (3, 4) for reducing the intensity of said light beam (5) so that an integration time for obtaining a response signal by integrating the light beam scattered (8) is extended, said method comprising the steps of:
challenging the optical identifier (2) of said information carrier (1) by a light beam (5),
detecting scattered light (8) scattered by the scattering medium (3) of said information carrier (1),
integrating said scattered light (8) over a period of time for obtaining a response signal, and
comparing the obtained response signal with a stored response signal associated with a corresponding challenge signal.

16. Non-clonable optical identifier (2), in particular for use in an information carrier as claimed in claim 1, comprising:
an optical scattering medium (3) for being challenged by a light beam (5) and for scattering said light beam (5), and
a light absorbing means (3, 4) for reducing the intensity of said light beam (5) so that an integration time for obtaining a response signal by integrating the light beam scattered (8) is extended.
